(19) United States
(12) Patent Application Publication
(10) Pub. No.: US 2025/0217628 A1
(43) Pub. Date: Jul. 3, 2025

(54) VARIATIONAL NEURAL NETWORK FOR REACTIVE METRIC MODELING

(71) Applicant: AMERICAN EXPRESS TRAVEL RELATED SERVICES COMPANY , INC., New Year, NY (US)

(72) Inventors: Artur SOKOLOVSKY, London (GB); Philipp BARTEL, London (GB); Leonie Tabea GOLDMANN, London (GB); Anton HINEL, London (GB)

(73) Assignee: AMERICAN EXPRESS TRAVEL RELATED SERVICES COMPANY, INC., New York, NY (US)

(21) Appl. No.: 18/400,787

(22) Filed: Dec. 29, 2023

(51) Int. Cl. G06N 3/0455; G06N 3/084

(52) U.S. Cl. CPC G06N 3/0455; G06N 3/084

(57) ABSTRACT

Disclosed herein are system, method, and computer program product embodiments for generating an expected data metric. A set of features is provided to a machine learning model. The machine learning module includes a linear neural network and a variational auto-encoder. The linear neural network uses the set of features to generate a first vector. The variational auto-encoder generates a second vector using the set of features. The expected data metric is determined based on an output vector. The output vector is obtained using the first vector and the second vector.

### TECHNICAL FIELD

This field is generally related to modelling a metric using a machine learning model and improving the reactivity of machine learning models.

### BACKGROUND

Companies use prediction models to determine metrics related to data or data sets. Metrics may be used in a decision making process. Prediction models may include artificial intelligence models. For example, lenders such as banks and credit card companies may develop models to estimate an expected default rate of a customer based on a plurality of factors. Companies may use the expected default rate to effectively manage portfolios and offer better conditions to customers. In addition, a trend associated with multiple metrics (e.g., default rates corresponding to a plurality of customers) may be affected by external factors such as macroeconomic changes.

Features used to model the default rates are impacted by the macroeconomic changes and their distributions and relations to the metric change over time. In machine learning this is called data and concept drifts. These are major bottlenecks for high-quality modelling of the expected default rates.

### SUMMARY

Disclosed herein are system, apparatus, device, method and/or computer program product embodiments, and/or combinations and sub-combinations thereof, for providing a prediction of a metric and improving the data drift reactivity of the model used to predict the metric. A set of features is input into a machine learning model. The machine learning model comprises a linear neural network and a variational auto-encoder. The linear neural network can determine a first vector based on the set of features. A second vector is determined based on a latent space of the variational auto-encoder. The first vector from the variational auto-encoder and the second vector from the linear neural network are concatenated to obtain an output vector. The metric is determined based on the output vector using a fully connected layer of the machine learning model.

### BRIEF DESCRIPTION OF THE DRAWINGS

The accompanying drawings are incorporated herein and form a part of the specification.

FIG. 1 depicts a block diagram of a system for predicting a metric, according to some embodiments.

FIG. 2A depicts a block diagram of a deep learning model, according to some embodiments.

FIG. 2B depicts a block diagram of a linear neural network of the deep learning model, according to some embodiments.

FIG. 2C depicts a block diagram of a variational auto-encoder of the deep learning model, according to some embodiments.

FIG. 3 depicts a flowchart illustrating a method for predicting a metric using a deep learning model, according to some embodiments.

FIG. 4A depicts graphs of predicted and actual values of a metric, according to some embodiments.

FIG. 4B depicts graphs of predicted and actual values of a metric, according to some embodiments.

FIG. 5 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for predicting a metric using a deep learning model and improving the reactivity of the model when predicting the metric.

A metric, predicted metric, and/or a predicted data metric may refer to one or more values produced by a machine learning model. For example, a metric may be generated from a set of data that has been applied to the machine learning model. The machine learning model may have been trained to generate this value or metric. In some aspects, the machine learning model may have been trained to predict a metric based on time series data. For example, a data set may include several monthly factors or elements that may be correlated with a particular data value for a particular month. The data set may include multiple months of data. Each month may include a data value and additional factors correlated to that data value. Upon applying the data set to the machine learning model, the machine learning model may generate a new data value or a predicted metric for a future month. In this manner, the metric or predicted metric may be generated based on the application of the machine learning model to the dataset. As further explained below, one example of such predictive modeling may be an average monthly default rate associated with a plurality of customers. For example, the metric may be a predicted default rate. Using the predicted default rate for each customer of the plurality of customers, an average monthly default rate may be determined. In other examples, the metric may be an operational and supply chain execution metric (e.g., performance metrics such as an average sales quantity). In addition, the metric may be associated with a user behavior (e.g., average spend on a credit card or a consumer spending pattern). The aspects disclosed herein, however, may be agnostic to the type of data analyzed and/or the types of metrics generated. Rather, the modeling framework described herein provides improved model reactivity so that the models are able to more quickly align and/or more accurately predict desired data metrics.

Some models used to estimate or predict a metric may have low accuracy or may be slow to respond to events, such as during times of economic or political uncertainty. For example, predictive models may not react in a timely manner to macroeconomic changes. To account for macroeconomic changes or other events, the reactivity problem may be addressed manually by modifying predictions generated by an artificial intelligence (AI) model. The reactivity problem may refer to a change in a trend due to the event such as the macroeconomic changes. For example, the macroeconomic changes during Covid-19 stressors have led to an increase in an error in determining an expected default rate of a customer. In one example, models (e.g., boosting trees) may suffer from a delay (or a lag) in reacting to such events. For example, the models may not model a change in the trend (e.g., a decrease in an average default rate) in a timely fashion. The model may show a decrease in the default rate few months later compared to the actual change in the trend.

Variational neural networks (VNNs) may accurately model uncertainty (e.g., provide accurate prediction during economic and political uncertainty). While VNNs are reactive, they may suffer from an offset in the predictions. For example, a VNN may accurately model a trend for the metric. However, there may be an offset between the predicted metric and the actual value of the metric. For example, the VNN may capture a decrease in an average rate during economic and political uncertainty in a timely fashion. However, the predicted average rate may be different from the actual average rate.

What is needed is a model that is capable of quickly reacting to changes and is capable to accurately predict the metric.

The deep learning model described herein comprises a linear neural network (LNN) component in addition to the variational neural network. The deep learning model treats the metric prediction as a classification problem. An input to the deep learning model may be a set of features and an output of the deep learning model may be the predicted metric. In some aspects, the metric may be an expected default rate of a customer. A default rate may refer to the probability that the customer will default on a loan. The deep learning model may generate an expected default rate for the customer. In some aspects, the metric may be a consumer spend prediction for the customer. The consumer spend prediction may refer to a total aggregate spending on one or more credit cards. In some aspects, the metric may be an expected average sale of a product. The expected average sale may refer to the anticipated quantity to be sold for the product in a given region.

The deep learning model described herein is reactive to uncertain times of recessions and crises. The deep learning model has an improved performance during rapid changes in external environments. In addition, an average monthly default rate associated with a plurality of customers is comparable to the actual average monthly default rate for the plurality of customers.

Various embodiments of these features will now be discussed with respect to the corresponding figures.

### System Overview and Function

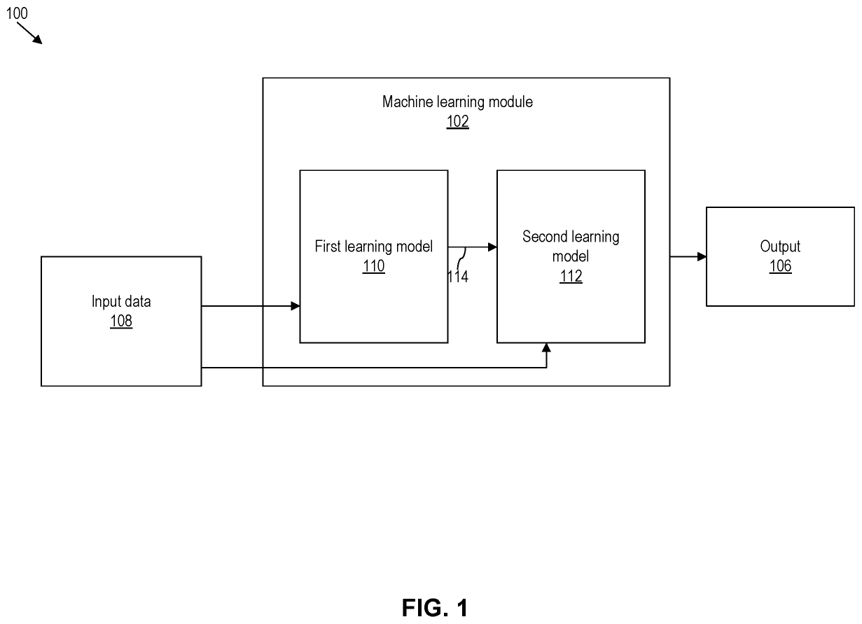

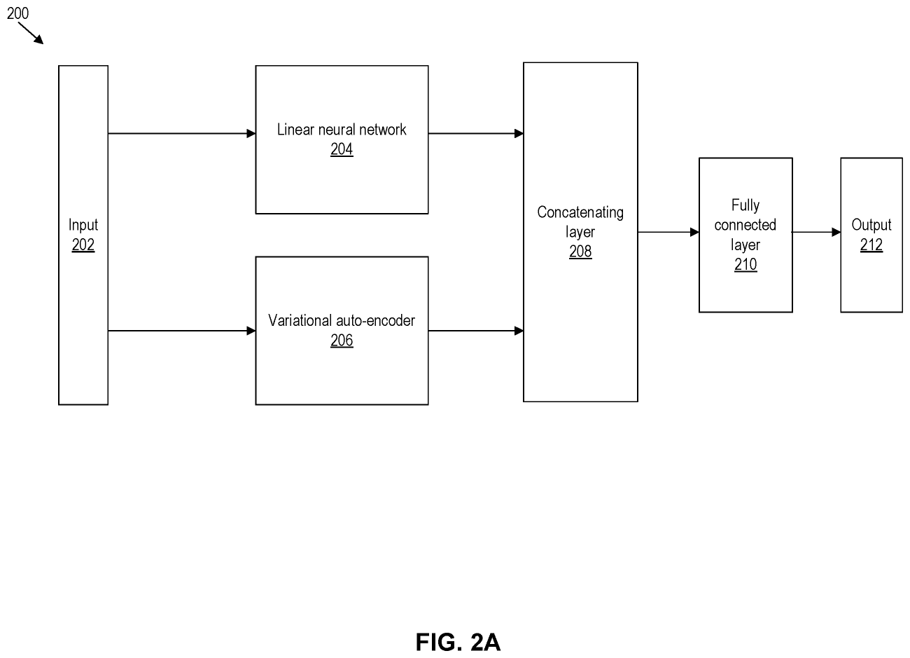

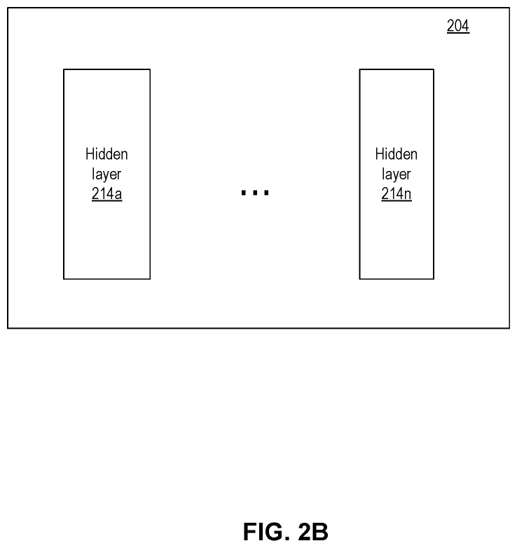

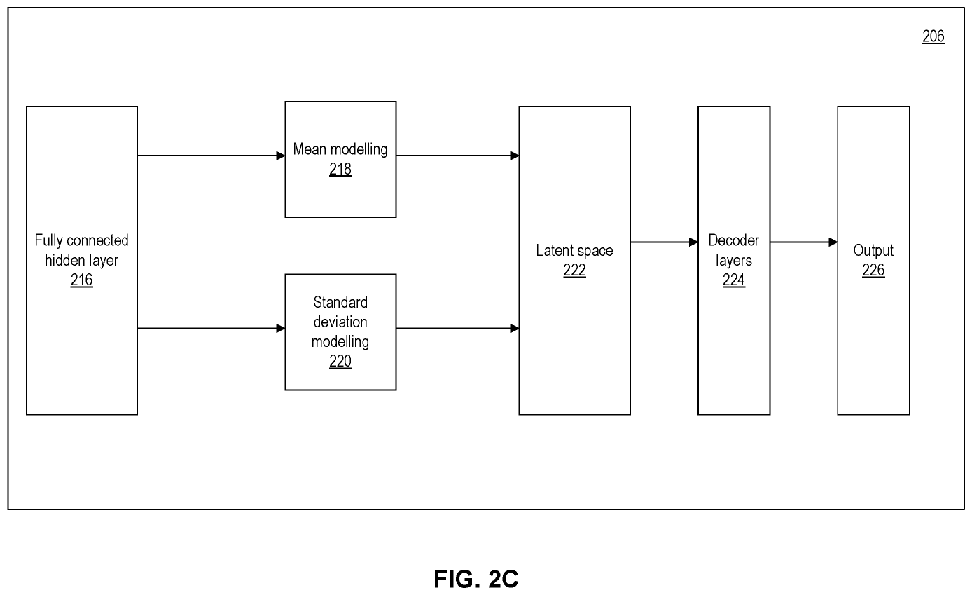

FIG. 1 depicts a block diagram of a system 100 for predicting a metric, according to some embodiments. System 100 may include a machine learning module 102. Machine learning module 102 may receive input data 108 and may generate an output 106. Input data 108 may include set of features associated with the customers. Machine learning module 102 may include one or more machine learning models. Machine learning module 102 may include a first learning model 110 and a second learning model 112. First learning model 110 may be a machine learning model such as a deep learning model as further described with reference to FIG. 2A. Second learning model 112 may be a machine learning model. Second learning model 112 may include at least one of a neural network, a deep neural network (DNN), a convolutional neural network (CNN), a linear regression model, a decision tree model, a generative model, and/or the like.

To generate output 106, first learning model 110 and/or second learning model 112 may receive input data 108 including the set of features. The set of features may be extracted from data associated with a user (e.g., a customer, a client). Input data 108 may be retrieved from a data store (e.g., a database, a cloud database) or other sources (e.g., crawl the web). The data store may be, for example, a data lake. System 100 may pull data in real time from one or more external systems. In addition, system 100 may extract the set of features from the pulled data. In some aspects, the set of features may correspond to input variables used in training of first learning model 110 and second learning model 112. As described above, output 106 may be an expected default rate for a customer.

Output 106 may represent a prediction of a metric. The metric may represent a default rate corresponding to the user. In some aspects, the metric may be a predicted monthly default rate. To generate the expected default rate, the one or more features may include credit bureau data (e.g., a FICO® score or a FICO band), customer income data, national average or historical and or projected statistics for similarly situated customers, assets, a number and type of transactions, macroscopic economic cycle factors (such as economic indexes and the like), an unemployment rate, an inflation rate, a balance associated with one or more accounts of the customer, number of cash transactions, and the like. Machine learning module 102 may retrieve one or more features in real-time.

In some aspects, the metric may be a consumer spend prediction. To generate the consumer spend prediction, the one or more features may include a consumer spend for the previous twelve month period, spending in each of the last quarters, number of cards associated with the customer, balances associated with one or more cards, a respective credit limit associated with the one or more cards, respective maximum and minimum balances associated with the one or more cards, an inflation rate, and macroscopic economic cycle factors.

In some aspects, the metric may be an expected average sale. To generate the expected average sale, the one or more features may include an inflation rate, historic performance and average sales, customer satisfaction metrics, marketing spend, political conditions, and an unemployment rate.

To generate output 106, first learning model 110 may receive input data 108 and generate a prediction 114 of the metric. Second learning model 112 may receive prediction 114 from first learning model 110 and input data 108 (e.g., the set of features) as inputs. In some aspects, output 106 may correspond to prediction 114 from first learning model 110. System 100 may provide output 106 to an external system or a financial entity.

To generate prediction 114, first learning model 110 may be trained using training data. As used herein, the term “train” refers to using information to tune or teach first learning model 110. Input data 108 may comprise records associated with a plurality of customers. One or more features may be extracted from each record of the plurality of customers. The one or more features may be used to train machine learning model 110. In some aspects, input data 108 may include records for the plurality of customers for at least three months. Training data may include records associated with the plurality of customers. The records may be for one or more years. In addition, the training data may include an actual default rate for each period (e.g., a monthly default rate) for each customer of the plurality of customers.

In some aspects, first learning model 110 may be trained to model accurately an average default rate. The average default rate may be generated by determining the expected default rate for each customer of the plurality of customers. Thus, first learning model 110 may be trained to minimize an error between an expected average monthly default rate and an actual average monthly default rate for the plurality of customers.

In some aspects, first learning model 110 may be trained to model accurately a consumer spend for each customer of the plurality of customers. First learning model 110 may be trained to minimize an error between an expected consumer spend and an actual consumer spend for a customer.

In some aspects, first learning model 110 may be trained to model accurately an expected average sale. The average sale may be generated by determining an expected average sale for each product of a plurality of products associated with a company. First learning model 110 may be trained to minimize an error between an expected average sale and an actual average sale.

In some aspects, first learning model 110 may include a neural network where a loss or cost function is defined to train the neural network. The neural network may include two or more parallel neural networks. The two or more parallel neural networks may include a variational component and a linear component. The linear component of first learning model 110 can model linear effects of the metric. In some aspects, the linear component has a capacity of summation and subtraction of the original weighted features (set of features).

The variational component may model the non-linear effects. The variational component of machine learning model 110 may model each record of input data 108 as a set of normal distributions in a latent space as further described with reference to FIG. 2C. In some embodiments, the variational component may include a multivariate data encoder using a variational auto-encoder approach.

The variational component is reactive when tested separately. In some aspects, each component may have an offset (e.g., predicting a higher or a lower monthly default rate compared to the actual default rate). However, when both components are trained as a single architecture, the offset is minimized. In addition, first learning model 110 (e.g., the variational component and the linear component) remains reactive.

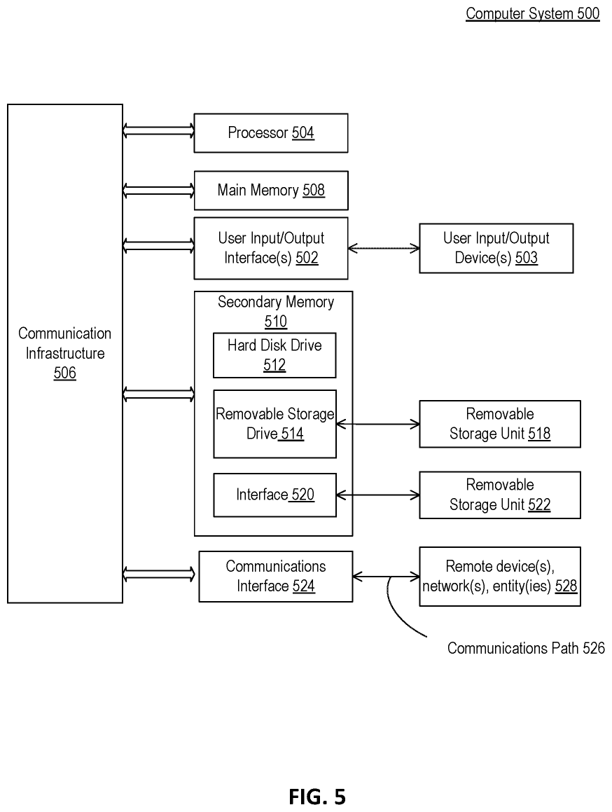

In some embodiments, system 100 may be implemented on one or more servers. The servers may be a variety of centralized or decentralized computing devices. For example, a server may be a mobile device, a laptop computer, a desktop computer, grid-computing resources, a virtualized computing resource, cloud computing resources, peer-to-peer distributed computing devices, a server farm, or a combination thereof. The servers may be centralized in a single room, distributed across different rooms, distributed across different geographic locations, or embedded within a network. The servers can couple with the network to communicate with other devices, such as a client device or a device associated with the financial entity. The client device may be any of a variety of devices, such as a smart phone, a cellular phone, a personal digital assistant, a tablet computer, a notebook computer, a laptop computer, a desktop computer, or a combination thereof. The servers and the client device may be stand-alone devices and work independently from one another. System 100 may be a computer system such as a computer system 500 described with reference to FIG. 5. For example, system 100 may be implemented using one or more servers and/or databases. System 100 may further include one or more operating systems.

System 100 described above improves the state of the art from conventional system in multiple ways. First, system 100 has the ability to accurately predict a metric during period of uncertainty without manual introduction of a multiplier (e.g., adjustments) to the model outputs. Thus, system 100 has the advantage of significant time and money savings.

Second, system 100 employs a novel architecture that allows system 100 to provide an accurate prediction without a lag or an offset. By combining two models and training the models jointly, duplicate operations are eliminated and thus system 100 is much faster and result in computational savings.

FIG. 2A depicts a block diagram of a deep learning model 200, according to some embodiments. Deep learning model 200 may include an input layer 202, a linear neural network (LNN) 204, a variational auto-encoder (VAE) 206, a concatenating layer 208, a fully-connected layer 210, and an output layer 212.

Input layer 202 may receive a set of features as input. The set of features may be extracted from input data 108. The output of input layer 202 may be received by linear neural network 204 and VAE 206. The set of features are applied to linear neural network 204 and VAE 206 to activate a first set of nodes of linear neural network 204 and VAE 206. Linear neural network 204 is further described with reference to FIG. 2B. Variational auto encoder 206 may include various layers where data can be encoded to generate a vector such as a latent vector. Variational auto encoder 206 is further described with reference to FIG. 2C. In some aspects, LNN 204 may generate a first output and VAE may generate a second output. In some aspects, the second output of VAE 206 may correspond to a sample or a representation from latent space 222.

The first output of LNN 204 and the second output of VAE 206 may be received by concatenating layer 208. Concatenating layer 208 may generate an output by concatenating the received outputs. In some aspects, an output of concatenating layer 208 has at least a dimension equal to the dimension of the first output and the dimension of the second output.

In some aspects, fully connected layer 210 receives the output from concatenating layer 208. Fully-connected layer 210 may include one or more fully-connected layers. Fully connected layer 210 takes an input of the size of the concatenated output from both models (linear neural network 204 and variational auto-encoder 206). Fully connected layer 210 may have an arbitrary number of neurons. Output layer 212 generates a prediction of the metric. In some aspects, output layer 212 generates prediction 114.

FIG. 2B depicts a block diagram of linear neural network 204 of deep learning model 200, according to some embodiments. Linear neural network 204 may comprise an arbitrary number of hidden layers (e.g., 214a . . . 214n). Linear neural network 204 receives inputs from input layer 202 and outputs the first output (e.g., a first vector) to concatenating layer 208. In some aspects, LNN 204 may output a vector for each record for each respective customer of the plurality of customers.

As described previously herein, LNN 204 is jointly trained with VAE 206. The training may comprise jointly updating VAE 206 parameters and VAE 206 parameters. In some aspects, LNN 204 and VAE 206 may be trained using a backpropagation technique. In some aspects, LNN 204 is trained without an activation function between the layers (e.g., between hidden layers 214a . . . 214n). Weights of hidden layers 214a . . . 214n are adjusted during training. The first vector is obtained as a linear function of inputs from input layer 202 based on the weights.

FIG. 2C depicts a block diagram of VAE 206, according to some embodiments. VAE 206 comprises a fully connected hidden layer 216, a probabilistic encoder comprising a mean modelling 218 and a standard deviation modelling 220, a latent space 222, decoder layers 224, and an output layer 226.

Fully connected hidden layer 216 receives the output of input layer 202 and processes the output by the probabilistic encoder (mean modelling 218 and standard deviation modelling 220). In some aspects, fully connected hidden layer 216 may include a plurality of hidden layers. In some aspects, the plurality of hidden layers may be fully-connected layers.

In some aspects, latent space 222 includes a latent representation from input data 108 (e.g., from the set of features). Latent space 222 comprises one or more latent variables that represent a compressed version of input data 108. VAE 206 learns parameters of a distribution over latent space 222. In some aspects, each latent state is modelled by a normal distribution. During training, model weights are adjusted so that each latent representation gets closer to the normal distribution. VAE 206 may be trained using two loss functions. The first loss function may include Kullback-leibler (KL) divergence. KL divergence may force each latent space to be normally distributed. In some aspects, for each record multiple representation may be drawn (as opposed to the LNN 204). Parameters of VAE 206 may be updated based on at least the loss value. In some aspects, a second loss function may include a mean square error. The mean square error may be used as a reconstruction component or reconstruction error. In some aspects, a binary cross entropy may be used as the loss function for fully connected layer 210. Decoder layers 224 may receive as input information sampled from the latent space 222 and produce an output 226 that is similar to input layer 202.

The second vector may be from latent space 222 of VAE 206. For example, the second vector may be a sample (also referred to as a representation) from latent space 222.

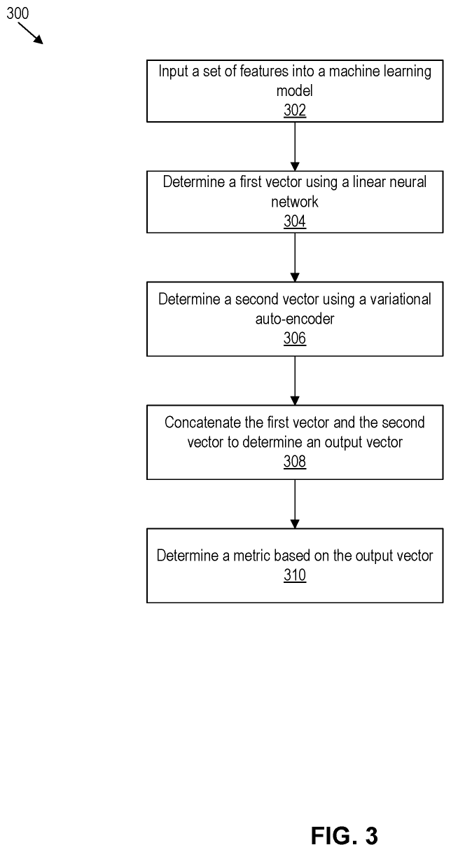

FIG. 3 depicts a flowchart illustrating a method 300 for predicting a metric value, according to some embodiments.

In an embodiment, system 100 may utilize method 300 to generate a prediction of the metric. Method 300 shall be described with reference to FIGS. 2A-2C, however, method 300 is not limited to that example embodiment. Method 300 may be executed on any computing device, such as, for example, the computer system described with reference to FIG. 5 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3, as will be understood by a person of ordinary skill in the art.

At 302, system 100 may input a set of features into a machine learning model. The machine learning model comprises a linear neural network (e.g., LNN 204) and a variational auto-encoder (e.g., VAE 206).

In some aspects, the machine learning model may be trained by simultaneously training the linear neural network 204 and the variational auto-encoder 206 using a backpropagation technique.

In some aspects, training data may include credit bureau data (e.g., a FICO® score or a FICO band), customer income data, national average or historical and or projected statistics for similarly situated customers, assets, a number and type of transactions, macroscopic economic cycle factors (such as economic indexes and the like), an unemployment rate, an inflation rate, a balance associated with one or more accounts of the customer, number of cash transactions, and the respective default rate for the plurality of customers. The default rate may be an actual monthly default rate for each customer.

At 304, system 100 may determine a first vector based on the set of features using the linear neural network. The first vector may obtained by applying weights associated with each of the hidden layers of the linear neural network to the set of features.

At 306, system 100 may determine a second vector based on the set of features using the variational auto-encoder. System 100 may determine a mean value and a standard deviation for the set of features. The mean value and the standard deviation defines the latent space. The mean value and the standard deviation are used to sample the latent space representation and determine the second vector (e.g., the second vector is drawn from the latent space). System 100 may generate a latent representation of the set of features based on the mean and the standard deviation. In some aspects, the latent representation is generated using a normal distribution based on the mean and the standard deviation.

At 308, system 100 may concatenate the second vector from the variational auto-encoder and the first vector from the linear neural network to obtain an output vector.

At 310, system 100 may determine a metric based on the output vector using a fully connected layer of the machine learning model. The machine learning model can be a reactive model that minimizes an error in predicting an average of metrics. Each metric may correspond to a respective set of features. In some aspects, the metric may be a predicted monthly default rate, a consumer spend prediction, or an expected average sale. For example, to generate an expected default rate of a first customer, the set of features may include a credit score associated with the first customer, income data of the first customer, a balance associated with the first customer. In addition, the set of features may also include the employment rate and the inflation rate for three or more months.

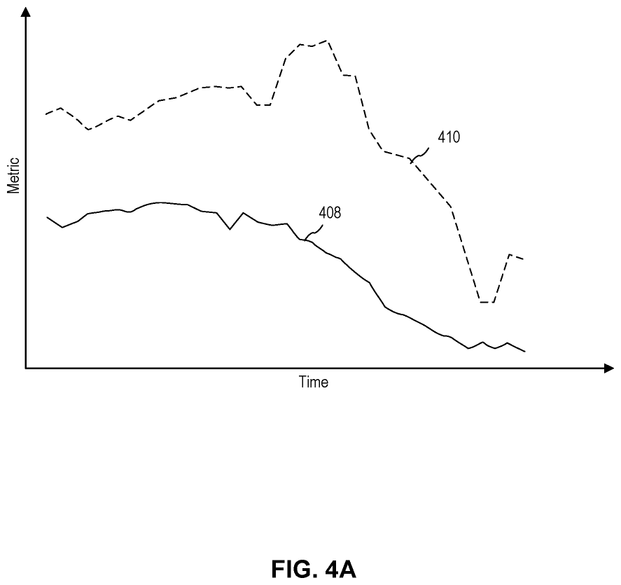

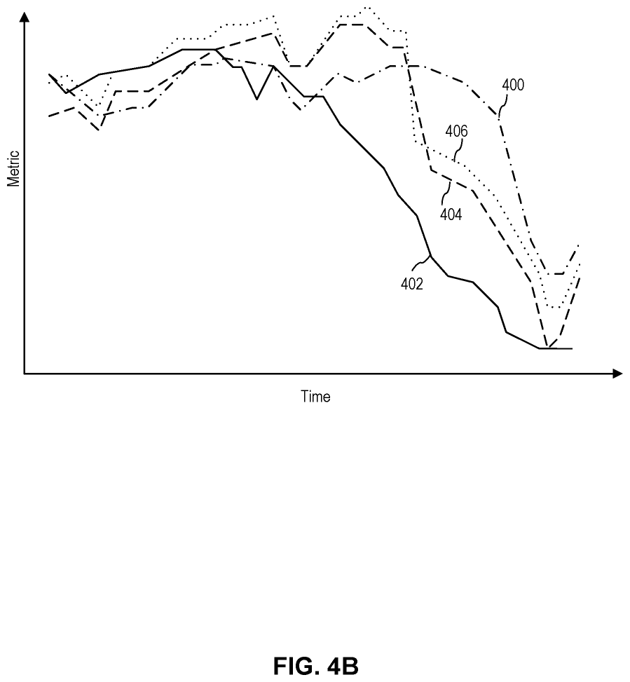

FIG. 4A depicts graphs of predicted and actual values of the metric using variational auto-encoder 206. Graph 408 shows an actual value of the metric (e.g., average default rate). Graph 410 shows a predicted value of the metric using variational auto-encoder 206. The predicted value of the metric may be obtained by obtaining the metric associated with a plurality of customers using VAE 206 and calculating the average value. Graph 410 shows that variational auto-encoder 206 is reactive (there is no lag with respect to the actual values). However, graph 410 shows an offset between the predicted value and the actual value.

FIG. 4B depicts graphs of predicted and actual values of a metric, according to some embodiments. Graph 402 shows an actual value of metric (e.g., average default rate). Graph 404 shows a predicted value of the metric using deep learning model 200. Graph 406 shows the predicted value of metric using second learning model 112 using as one of the input the output of deep learning model 200. Graph 400 shows the predicted value using second learning model 112. Graph 400 shows a lag with respect to the actual values of the metric (the decrease in the average default rate is at a later time compared to the actual value). Thus, second learning model 112 is not a reactive model. However, the output of second learning model 112 and first learning model 110 is reactive as shown by graph 406 (the decrease in the average default rate is seen earlier in time compared to second learning model 112). Thus, deep learning model 200 has improved reactivity. In addition, there is no offset between the actual value and the predicted value (e.g., the offset shown by graph 410 has disappeared). Reactivity in the example shown in FIGS. 4A and 4B may refer to a predicted decrease in the average default rate.

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
inputting, by at least one processor, a set of features into a machine learning model, wherein the machine learning model comprises a linear neural network and a variational auto-encoder;
determining, by the at least one processor and using the linear neural network, a first vector based on the set of features;
determining, by the at least one processor and using the variational auto-encoder, a second vector based on the set of features;
concatenating, by the at least one processor, the first vector from the variational auto-encoder and the second vector from the linear neural network to obtain an output vector; and
determining, by the at least one processor and using a fully connected layer of the machine learning model, a metric based on the output vector, wherein the machine learning model is a reactive model that decreases an error in predicting an average of metrics, and wherein each metric corresponds to a respective set of features.

2. The method of claim 1, wherein determining the second vector further comprises:
determining a mean value and a standard deviation associated with a latent space of the variational auto-encoder; and
generating a latent representation based on the mean and the standard deviation, wherein the second vector corresponds to the latent representation.

3. The method of claim 2, wherein the latent representation is generated using a normal distribution based on the mean and the standard deviation.

4. The method of claim 1, further comprising:
simultaneously training the linear neural network and the variational auto-encoder using a backpropagation technique.

5. The method of claim 4, wherein the training further comprises:
using a Kullback-leibler (KL) divergence and mean square error as a reconstruction component of loss function for the variational auto-encoder; and
using a binary cross-entropy as the loss function for the fully-connected layer.

6. The method of claim 1, wherein the metric is a first metric and the machine learning model is a first machine learning model; and wherein the method further comprises:
providing the first metric as an input to a second machine learning model, wherein the second machine learning model receives the set of features and the first metric as inputs and outputs a second metric, the second metric being another prediction of the first metric.

7. The method of claim 1, wherein the metric is a prediction of a default rate of a customer.

8. The method of claim 1, wherein a size of an input of the fully connected layer corresponds to a size of the output vector.

9. The method of claim 1, wherein the variational auto-encoder models a probability distribution of a latent variable of the set of features based on a normal distribution.

10. The method of claim 1, wherein the variational auto-encoder comprises a plurality of fully-connected layers.

11. A system, comprising:
a memory; and
at least one processor coupled to the memory and configured to:
input a set of features into a machine learning model, wherein the machine learning model comprises a linear neural network and a variational auto-encoder;
determine, using the linear neural network, a first vector based on the set of features;
determine, using the variational auto-encoder, a second vector based on the set of features;
concatenate the first vector from the variational auto-encoder and the second vector from the linear neural network to obtain an output vector; and
determine, using a fully connected layer of the machine learning model, a metric based on the output vector.

12. The system of claim 11, wherein the at least one processor is further configured to:
determine a mean value and a standard deviation associated with a latent space of the variational auto-encoder; and
generate a latent representation of the set of features based on the mean and the standard deviation, wherein the second vector corresponds to the latent representation.

13. The system of claim 11, wherein the at least one processor is further configured to:
simultaneously train the linear neural network and the variational auto-encoder using a backpropagation technique.

14. The system of claim 13, wherein the at least one processor is further configured to:
use a Kullback-leibler (KL) divergence and mean squared error as a reconstruction component as a loss function for the variational auto-encoder; and
use a binary cross-entropy as the loss function for the fully-connected layer.

15. The system of claim 11, wherein the metric is a first metric and the machine learning model is a first machine learning model; and wherein the at least one processor is further configured to:
provide the first metric as an input to a second machine learning model, wherein the second machine learning model receives the set of features and the first metric as inputs and outputs a second metric.

16. The system of claim 11, wherein the metric is a prediction of a default rate of a customer.

17. The system of claim 11, wherein a size of an input of the fully connected layer corresponds to a size of the output vector.

18. The system of claim 11, wherein the variational auto-encoder models a probability distribution of a latent variable of the set of features based on a normal distribution.

19. The system of claim 11, wherein the variational auto-encoder comprises a plurality of fully-connected layers.

20. A non-transitory computer-readable device having instructions stored thereon that, when executed by at least one computing device, cause the at least one computing device to perform operations comprising:
inputting a set of features into a machine learning model, wherein the machine learning model comprises a linear neural network and a variational auto-encoder;
determining, using the linear neural network, a first vector based on the set of features;
determining, using the variational auto-encoder, a second vector based on the set of features;
concatenating the first vector from the variational auto-encoder and the second vector from the linear neural network to obtain an output vector; and
determining, using a fully connected layer of the machine learning model, a metric based on the output vector.
